(19) United States
(12) Patent Application Publication
(10) Pub. No.: US 2017/0353265 A1
(43) Pub. Date: Dec. 7, 2017

(54) Spatial Mode Multiplexer With Optical Reference Path

(71) Applicants: Mohammad Mehdi MANSOURI RAD, Kanata (CA); Irfan Muhammad Fazal, Ottawa (CA)

(72) Inventors: Mohammad Mehdi MANSOURI RAD, Kanata (CA); Irfan Muhammad Fazal, Ottawa (CA)

(21) Appl. No.: 15/208,236

(22) Filed: Jul. 12, 2016

Related U.S. Application Data
(63) Continuation-in-part of application No. 15/171,175, filed on Jun. 2, 2016.

(51) Int. Cl. H04J 14/04; H04Q 11/00; H04B 10/079; H04J 14/02

(52) U.S. Cl. CPC H04J 14/04; H04J 14/0227; H04Q 11/0066; H04B 10/0795; H04Q 2011/0049; H04Q 2011/0083; H04Q 2011/0024

(57) ABSTRACT

A spatial mode multiplexer for multiplexing optical signals onto different spatial modes includes an optical path for directing a probe signal through a mode converter of the multiplexer. A spatial profile of an optical phase of the probe signal is detected e.g. by splitting the reference signal into monitoring and reference paths to produce an interference pattern that can be captured and processed to control the spatial mode converters.

### RELATED APPLICATIONS

The current application is a Continuation-In-Part to U.S. application Ser. No. 15/171,175, filed Jun. 2, 2016, the entirety of which is hereby incorporated by reference for all purposes.

### TECHNICAL FIELD

The current disclosure relates to an optical multiplexer, and in particular to spatial mode multiplexers.

### BACKGROUND

Spatial division multiplexing (SDM) of optical signals provides increased capacity over an optical link. SDM multiplexers may use spatial mode converters for converting a mode of an optical signal in order to allow it to be spatially multiplexed with another optical signal. Ideally, the spatial modes are orthogonal to each other in order to prevent crosstalk between the spatially multiplexed optical signals. However, in practice the spatial modes are not completely orthogonal to each other and allow optical power to leak between the different spatial modes. The inter-mode power leakage can result in undesirable crosstalk between the optical signals of the different spatial modes. Tuning of the mode converters may help reduce the crosstalk between optical signals. The crosstalk tuning requires monitoring of the optical signals in order to provide feedback on adjusting the mode converters.

An additional, alternative, and/or improved SDM multiplexer for monitoring optical signals is desirable.

### SUMMARY

In accordance with the present disclosure there is provided a spatial mode multiplexer comprising: a spatial mode converter for converting a spatial mode of an optical signal; a transmit optical path for propagating the optical signal, wherein the transmit optical path is coupled to the spatial mode converter; a monitoring optical path comprising a branch coupled to the spatial mode converter; and an optical coupling element for optically coupling at least a portion of the optical signal having the spatial mode converted by the spatial mode converter to at least one of: an output transmit path for propagating the converted spatial mode; and a monitoring sensor path for coupling to an optical sensor for detecting an optical signal propagated along the monitoring optical path.

In a further embodiment, the spatial mode multiplexer further comprises a reference optical path bypassing the spatial mode converter and configured for combining an optical signal propagated along the reference optical path with the optical signal propagated along the monitoring optical path to obtain an optical interference pattern at the optical sensor.

In a further embodiment, the spatial mode multiplexer further comprises the optical sensor.

In a further embodiment, the spatial mode multiplexer further comprises a controller operably coupled to the optical sensor and configured for: obtaining the optical interference pattern from the optical sensor; comparing the optical interference pattern with a reference pattern; and providing a feedback signal to the spatial mode converter for changing the spatial mode of the optical signal so as to lessen a difference between the optical interference pattern and the reference pattern.

In a further embodiment, the spatial mode multiplexer further comprises a light source optically coupled to the monitoring and reference optical paths, for providing the optical signal for propagation along the monitoring and reference optical paths.

In a further embodiment, the spatial mode multiplexer further comprises: a second spatial mode converter for converting a spatial mode of a second optical signal; a second transmit optical path for propagating the second optical signal, wherein the second transmit optical path is coupled to the second spatial mode converter; wherein the monitoring optical path further comprises a second branch coupled to the second spatial mode converter, and wherein the optical coupling element is further for coupling at least a portion of the optical signal having the spatial mode converted by the second spatial mode converter to at least one of: the output transmit path; and the monitoring optical path.

In a further embodiment of the spatial mode multiplexer, the spatial mode multiplexer comprises an orbital angular momentum (OAM) multiplexer, wherein the spatial mode converter comprises a spatial light modulator (SLM) for providing a pre-determined spatial phase pattern to the optical signal, and wherein the second spatial mode converter comprises a second spatial light modulator (SLM) for providing a pre-determined spatial phase pattern to the second optical signal.

In a further embodiment of the spatial mode multiplexer, outputs of the SLM and second SLM are optically combined to provide a spatially multiplexed optical signal to the optical coupling element.

In a further embodiment, the spatial mode multiplexer further comprises a third transmit optical path for optically combining a third optical signal with the outputs of the SLM and the second SLM, the third optical signal having spatial mode that can be spatially multiplexed with the outputs of the SLM and second SLM.

In a further embodiment, the spatial mode multiplexer further comprises the optical sensor and a controller operably coupled thereto and configured for: obtaining the optical interference pattern from the optical sensor; comparing the optical interference pattern with a reference pattern; and providing a feedback signal to the SLM and the second SLM for changing the spatial mode of the optical signal so as to lessen a difference between the optical interference pattern and the reference pattern.

In a further embodiment, the spatial mode multiplexer further comprises a light source optically coupled to the monitoring and reference optical paths, for providing the optical signal for propagation along the monitoring and reference optical paths.

In a further embodiment, the spatial mode multiplexer further comprises: at least one additional spatial mode converters for converting a spatial mode of a respective one of at least one additional optical signals; at least one additional transmit optical path for propagating a respective one of the at least one additional optical signals, wherein each one of the at least one additional transmit optical paths is coupled to a respective one of the at least one additional spatial mode converters; wherein the monitoring optical path further comprises at least one additional branch coupled to a respective one of the at least one additional spatial mode converters, and wherein the optical coupling element is further for coupling at least a portion of the optical signal having the spatial mode converted by the respective at least one additional spatial mode converter to at least one of: the output transmit path; and the monitoring sensor path.

In a further embodiment, the spatial mode multiplexer further comprises: the optical sensor for detecting the optical signal propagated along the monitoring sensor path; and a reference monitoring path branch of the monitoring optical path for propagating a reference monitoring signal to the sensor.

In a further embodiment of the spatial mode multiplexer, the optical sensor comprises a photodetector array arranged at an interference location between optical signals propagating on the reference monitoring path branch and the monitoring sensor path.

In a further embodiment of the spatial mode multiplexer, the optical coupling element comprises: a WDM coupler; a beam splitter/combiner; a flip mirror; or an optical switch.

In a further embodiment, the spatial mode multiplexer further comprises a monitoring path optical coupling element for optically coupling the branch of the monitoring optical path to the transmit optical path upstream of the spatial mode converter.

In a further embodiment of the spatial mode multiplexer, the monitoring path optical coupling element comprises one or more of: a WDM coupler; a beam splitter/combiner; a flip mirror; and an optical switch.

In a further embodiment of the spatial mode multiplexer, the monitoring optical path comprises: a beam splitter for splitting a monitoring optical signal between the monitoring and reference optical paths; and a monitoring branch optical coupling element in the monitoring optical path downstream of the beam splitter for coupling a portion of the monitoring optical signal to the branch of the monitoring optical path and the second branch of the monitoring optical path.

In a further embodiment of the spatial mode multiplexer, the monitoring branch optical coupling element selectively couples the portion of the monitoring optical signal to one of the branch of the monitoring optical path and the second branch of the monitoring optical path.

In accordance with the present disclosure there is provided a method for configuring a spatially multiplexed optical link, the method comprising: receiving a probe optical signal; spatially modulating at least a portion of the probe optical signal at a spatial mode converter used for converting a spatial mode of a transmit optical signal for transmission to a destination; coupling the spatially modulated probe optical signal to an optical sensor; and generating a feedback signal for adjusting the spatial mode converter based on an output of the optical sensor.

In a further embodiment of the method, the transmit optical signal is not present at the spatial mode converter prior to generating the feedback signal.

In a further embodiment of the method, the transmit optical signal is present at the spatial mode converter during generation of the feedback signal.

In a further embodiment of the method, an optical frequency of the monitoring signal falls outside of an optical frequency spectrum of the transmit optical signal, or falls between channel frequencies of the transmit optical signal.

In a further embodiment the method further comprises splitting the received probe optical signal into a monitoring optical signal for propagation through the spatial mode converter and a reference optical signal bypassing the spatial mode converter, and combining the monitoring optical signal propagated through the spatial mode converter with the reference optical signal, so as to form an optical interference pattern for detection by the optical sensor.

In a further embodiment of the method, the optical sensor comprises a detector array, and the method further comprises: capturing the optical interference pattern by the detector array.

In a further embodiment the method further comprises the captured optical interference pattern with a reference pattern, wherein the feedback signal is generated based on a difference between the optical interference pattern and the reference pattern.

### BRIEF DESCRIPTION OF THE DRAWINGS

Embodiments are described herein with reference to the appended drawings, in which:

FIG. 1 depicts SDM incorporating an integrated reference path for monitoring coupling efficiency of spatial modes;

FIG. 2 depicts an SDM multiplexer incorporating an integrated monitoring path;

FIGS. 3A and 3B depict interference images of spatial modes;

FIG. 4 depicts a further OAM-SDM multiplexer incorporating an integrated reference optical source;

FIG. 5 depicts a frequency spectrum of a WDM optical signal along with monitoring signals;

FIG. 6 depicts an OAM-SDM multiplexer incorporating a plurality of integrated reference optical sources;

FIG. 7 depicts a schematic of an optical network and control system that may incorporate SDM multiplexers; and

FIG. 8 depicts a distributed spatial light modulator (SLM) controller.

### DETAILED DESCRIPTION

Optical networks transmit optical signals from a source to a destination over an optical link, which may be provided by an optical fiber. Optical fibers may be designed and fabricated that allow multiple spatial modes to be transmitted over the single fiber. Such fibers may be used to spatially multiplex a plurality of optical signals on a single fiber, and may be referred to as spatial division multiplexing (SDM) fibers. SDM fibers may include, for example, multi-core fibers, few-mode or multi-mode fibers, hybrid multi-core multi-mode fibers, ring core fibers, hollow-core fibers or orbital angular momentum (OAM) fibers. Additionally or alternatively, an SDM optical link may be provided by a free-space optical link. An SDM multiplexer can multiplex optical signals onto different spatial modes that can be launched into the SDM fiber. The SDM multiplexer may monitor characteristics of optical signals prior to transmitting data over the optical link in order to tune the SDM multiplexer for improved performance, such as reduced inter-mode crosstalk.

As described in U.S. application Ser. No. 15/171,175, filed Jun. 2, 2016 and incorporated herein by reference in its entirety, the SDM multiplexer may monitor the optical signals from transmitters. Such a monitoring arrangement requires the data transmitting light sources provide optical signals suitable for monitoring, which may not always be possible. For example, if the optical link is not in use (no spatial mode is carrying signals), the data transmitters may not output optical signals. Similarly the optical signal is only available for spatial modes which carry traffic. This means that for spatial modes that not being used, i.e., spatial modes with no optical signal present, the corresponding optical path of the spatial mode is dark and no monitoring is possible. Without any monitoring, SDM coupling optimizations cannot be done. This monitoring blindness for dark optical paths may create uncertainty in the overall performance once traffic is expected to be carried in a dark mode especially during establishing a channel. This is because the traffic optical signal presence is necessary to perform monitoring for the purpose of any alignment and performance optimization. Alternatively, performing in-service monitoring using the traffic optical signals, during use, creates a trade-off between loss, and complexity of the control scheme. In order to perform optimized alignment for SDM coupling the traffic signal has to be tapped and monitored, which imposes insertion loss, and the corresponding algorithm has to cover all scenarios involving reliability of the traffic signals as a reference source for monitoring resulting in higher software complexity. This is not a desirable problem to be solved as any trade-off will add to the cost of the system, in terms of performance, link budget power, software complexity, etc. Clearly the reliability of the reference monitoring signal will directly depend on the reliability of the traffic signal which may experience unexpected power perturbations. In an ideal architecture the SDM multiplexer and de-multiplexers act transparently to the traffic and the physical properties of the established optical path for a particular SDM mode are monitored and optimized in real time, independent of the optical traffic signals. The monitoring of the optical path properties independent of the traffic signals of the optical path of a spatial mode allows control of the optical path for optimal alignment no matter if an optical traffic signal is present or not. As described further herein, an SDM multiplexer may include an integrated reference path that allows monitoring and tuning of the SDM multiplexer independent of the optical signals used for data transmission. Such an architecture for SDM multiplexer/demultiplexer allows the SDM mux/demux to be tuned so that when a data path is commissioned, the multiplexer components are properly tuned and data transmission can begin without first performing a tuning procedure. The improved performance may provide significant time saving in establishing data paths for dynamic networks. Further, such an SDM multiplexer may be used to monitor and tune the multiplexer components while the optical link is in service and transmitting data.

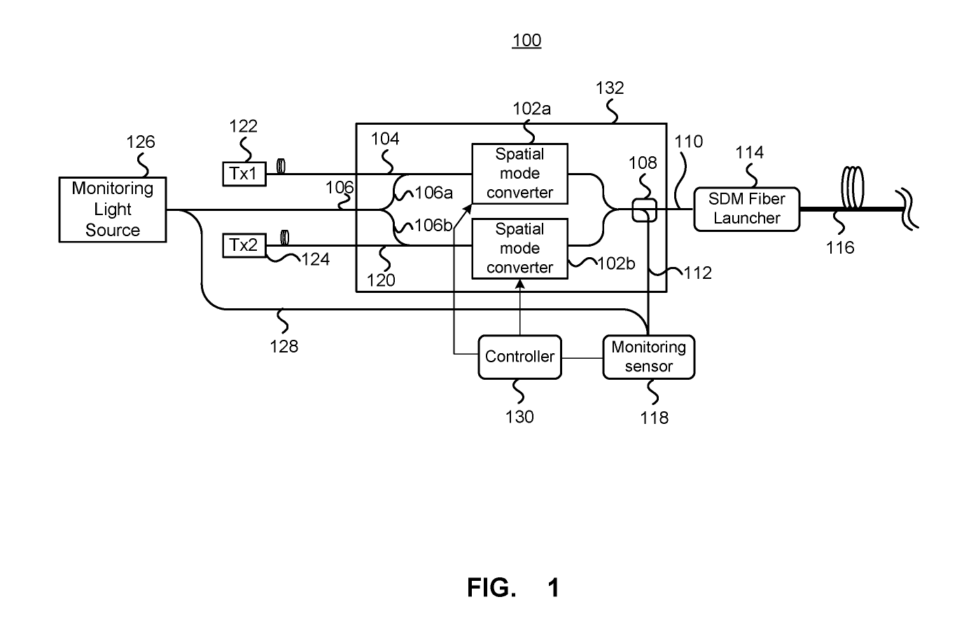

FIG. 1 depicts an SDM transmission system incorporating an integrated reference path for monitoring coupling efficiency of spatial modes. The SDM transmission system 100 is depicted as comprising two spatial mode converters 102a, 102b that can each convert a spatial mode of a respective optical signal in order to allow multiple optical signals to be spatially multiplexed on an optical link. A first optical signal to be transmitted to a destination may be propagated to the first spatial mode converter 102a over an input transmission path 104 that is optically coupled to the first spatial mode converter 102a. Similarly, a second optical signal to be transmitted to the destination may be propagated to the second spatial mode converter 102b. In order to enable monitoring and tuning of the spatial mode converters independent of the optical signals to be transmitted to the destination, a monitoring path 106 is also optically coupled to each of the spatial mode converters 102a, 102b. The monitoring path 106 may be split into respective optical paths 106a, 106b coupling to one of the spatial mode converters 102a, 102b, either physically using a beam splitter, array waveguides, or similar optical components, or selectively using one or more controllable components such as an optical switch or switching cell. The separate monitoring path 106 allows a monitoring, or probe, optical signal to pass through the spatial mode converters 102a, 102b in order to monitor the performance of the spatial mode converters. The separate monitoring path 106 allows the monitoring optical signal to be provided separately from the optical signals for transmission.

The spatial mode converter 102a converts the spatial mode of an optical signal present on monitoring path 106a and the input transmission path 104. Similarly, the spatial mode converter 102b converts the spatial mode of an optical signal present on monitoring path 106b and an input transmission path 120. The output of the spatial mode converters 102a, 102b may be optically coupled to an optical coupling element 108 that optically couples at least a portion of the output of the spatial mode converters 102a to an output transmission path 110 or to a monitoring sensor path 112. The optical paths may be provided in a variety of ways, including as free-space paths using various arrays of lenses collimators, etc. Additionally or alternatively, the optical paths may be provided using other techniques including those based on silicon photonics. The SDM transmission system may incorporate optical paths using a combination of different techniques.

The optical coupling element 108 is capable of directing an optical signal for transmission to an SDM fiber launcher 114 over the output transmission path 110. The SDM fiber launcher 114 launches an SDM optical signal into an SDM optical fiber 116 for transmission to the destination. The optical coupling element 108 is further capable of directing an optical signal for monitoring the spatial mode converter 102 to be directed to monitoring sensor path 112 that is optically coupled to a monitoring sensor 118, such as a camera, photodetector array, or optical phase sensor. The optical phase sensor may comprise, for example, a microlens array coupled to an array of miniature quadrant detectors. The monitoring sensor 118 can provide feedback information for use in adjusting transmission characteristics, including tuning of the spatial mode converter 102, in order to reduce crosstalk between spatial modes and increasing the coupling efficiency such as reducing loss.

The optical coupling element 108 allows a monitoring signal present on the monitoring path to pass through the spatial mode converters 102a, 102b and to be propagated to the monitoring sensor 118, while allowing a transmission signal present on the input transmission paths 104, 120 to pass through the spatial mode converters 102a, 102b and propagate to the output transmission path 110 for launching into the SDM fiber. The optical coupling element 108 may be provided by various components, such as an optical splitter, flip mirror, frequency selective splitter, an optical switch, or other optical elements capable of directing the monitoring signal to the monitoring sensor path. Depending upon the implementation of the optical coupling element 108, as well as other elements of the SDM transmission system, it may be possible to direct the monitoring signal to the monitoring sensor path 112 at the same time as the transmission signals are directed to the output transmission path. Alternatively, the optical coupling element 108 may direct, or couple, the monitoring signal and the transmission signals, if present, to a common location. For example, both the monitoring signal and the transmission signals, if present, may be directed together to the monitoring sensor path 112 or both the monitoring signal and the transmission signals, if present, may be directed together to the output transmission path 110.

Although various implementations of the SDM transmission system 100 are possible, FIG. 1 depicts the spatial mode converters 102a, 102b and the optical coupling element 108 as being incorporated into an SDM multiplexer/demultiplexer (Mux/Demux) 132. It is noted that only the transmission portion of the SDM Mux/Demux 132 are depicted for simplicity. The SDM Mux/Demux 132 may include an input for a monitoring signal, which may then be split to the monitoring paths 106a, 106b, as well as inputs for the optical signals to be spatially multiplexed and transmitted to a destination. The SDM Mux/Demux 132 may include optical outputs for the transmission optical signal as well as the monitoring optical signal. Further, the SDM Mux/Demux 132 may include inputs for providing control signals to the spatial mode converters 102a, 102b in order to adjust the performance based on the feedback provided by the monitoring signal.

The SDM Mux/Demux 132 is depicted as being optically coupled to respective transmitters 122, 124 that provide the optical signals for transmission to the destination. The transmitters 122, 124 may be connected to the SDM Mux/Demux 132 via a fiber optic cable. The transmitters 122, 124 output the optical signals, which may include wave division multiplexed (WDM) signals, or other types of optical signal.

A monitoring light source 126 may be coupled to the SDM Mux/Demux 132 in order to provide the monitoring signal. As depicted, the monitoring light source 126 may be split to provide a reference optical path 128 that can supply a reference optical signal to the monitoring sensor 118. The reference monitoring signal provides a version of the monitoring signal to the monitoring sensor 118 that provides a reference of the monitoring signal that has not passed through the spatial mode converters 102a, 102b. The monitoring sensor 118 may or may not utilize the reference monitoring signal in measuring or monitoring the characteristics of the spatial mode converters 102a, 102b. As an example, the monitoring sensor 118 may measure an optical power of the reference monitoring signal as compared to the optical power of the monitoring signal having passed through one of the spatial mode converters 102a, 102b. As a further example, the monitoring sensor 118 may combine the reference monitoring signal with the monitoring signal having passed through one of the spatial mode converters 102a, 102b in order to generate an interference pattern which may be captured by an imaging array of the monitoring sensor 118 and processed, for example by a controller 130.

The controller 130 may process information received from the monitoring sensor 118 in order to determine adjustments that may be made to the spatial mode converters 102a, 102b in order to provide improved spatial mode alignment of the spatially multiplexed signals. The controller 130 may use various techniques for determining adjustments based on the monitoring sensor 118 information. For example, the controller 130 may compare a captured interference pattern to a reference interference pattern associated with a particular spatial mode and determine adjustments to be made, for example to the spatial mode converter 102, to shift the captured interference pattern to the interference pattern.

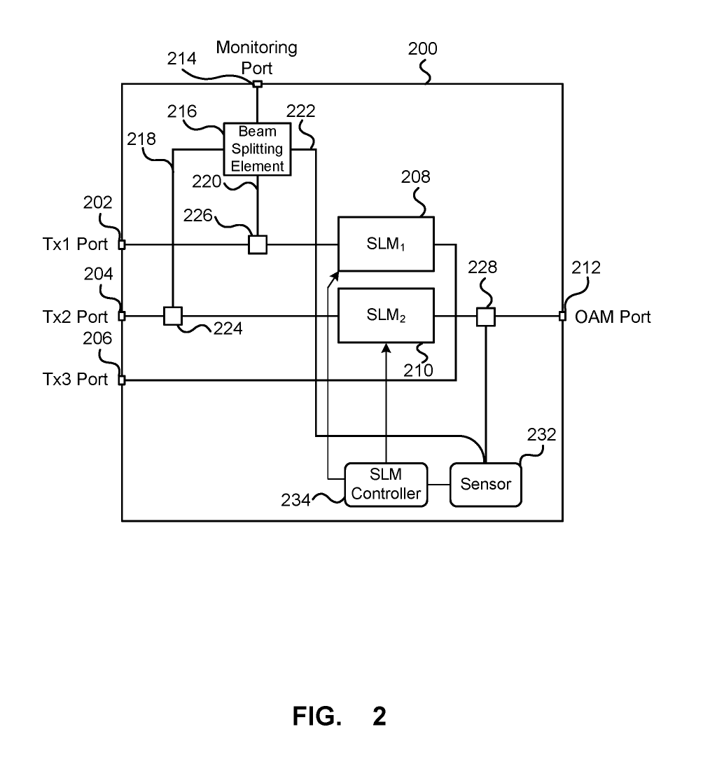

FIG. 2 depicts an SDM multiplexer incorporating an integrated monitoring path. The SDM multiplexer 200 may be used in an SDM transmission system such as the system described above with reference to FIG. 1. The SDM multiplexer 200 is an orbital angular momentum (OAM) multiplexer. The multiplexer 200 receives optical signals at transmission ports 202, 204, 206 that will be spatially multiplexed together and output at an OAM port 212. As depicted, two spatial light modulators (SLMs) 208, 210 convert the optical signals coupled to the transmission ports 202, 204 to the OAM modes. The SLMs 208, 210 may be liquid crystal light modulators that operate as variable phase masks. For example, the first and second SLMs 208, 210 may each be a Liquid Crystal on Silicon-Spatial Light Modulator (LCOS-SLM) which is a reflection-type spatial light modulator that phase-modulates the light by controlling the wavefront of the reflected light.

The optical signal coupled to the transmission port 206 is not converted as it is assumed to have a fundamental mode which can be spatially multiplexed with the converted modes output from the SLMs 208, 210. That is, the SLM 208 may convert a signal from the first transmission port 202 to have an OAM+1 mode, the SLM 210 may convert a signal from the second transmission port 204 to have an OAM−1 and the signal from the third transmission port 206 may have a fundamental OAM−0 mode. The designations OAM+1 and OAM−1 are used herein to signify that the OAM modes have opposite helical directions. The three OAM modes, namely OAM−1, OAM−0, OAM+1 may be spatially multiplexed together and output from the OAM port 212 in order to be launched into an SDM fiber.

As depicted, in addition to the transmission paths that propagate transmission signals from the transmit ports 202, 204, 206 to the OAM port 212, the multiplexer 200 further includes integrated monitoring paths that allow monitoring and adjusting performance characteristics independent of the optical signals for transmission. The multiplexer 200 comprises a monitoring port 214 that receives an optical signal used for monitoring the multiplexer's performance. The monitoring signal is split by a beam splitting element 216 into a number of monitoring path branches 218, 220 and a reference monitoring path branch 222. The reference monitoring signal may be recombined with monitoring signals that have passed through and been modulated by the SLMs 208, 210 to generate interference patterns. The other branches 218, 220 are coupled to respective ones of the SLMs 208, 210. The beam splitting element may be implemented in a number of ways, including using beam splitter array waveguides, directional couplers, or optical switches. If the beam splitting element is provided by a beam splitter, the monitoring signal will be present at monitoring path branches 218, 220 which may not be required and will impose an optical power loss of the monitoring signal. An optical switch may be used as a portion of the beam splitting element 216 in order to switch the optical signal to one or the other of the monitoring paths 218, 220.

The monitoring path branch 220 is coupled to an optical path coupling the first transmission port 202 to the first SLM 208. As depicted the coupling may be done by an optical coupling element 226 such as beam splitter/combiner that combines both paths into a single path coupled to the SLM 208. Alternatively, the optical coupling element 226 may be provided by a WDM combiner, switch, flip mirror, directional coupler, etc. Similarly, the monitoring path branch 218 is coupled to an optical path coupling the second transmission port 204 to the second SLM 210. As depicted, the coupling may be done by an optical coupling element 224 such as beam splitter/combiner that combines both paths into a single path coupled to the SLM 210. The optical coupling element may be similar to the optical coupling element 226 and may be provided by a WDM combiner, switch, flip mirror, directional coupler, etc. With the monitoring signals passing through the SLMs, the modes of the monitoring signals are converted along with the transmission signals.

The optical coupling elements 224, 226 may couple optical signals from the monitoring paths 218, 220 and the transmission ports 202, 204 to the respective SLMs 208, 210 simultaneously or individually. If each of the optical coupling elements 224, 226 couple the transmission signal and the monitoring signal to the respective SLM simultaneously, it is possible to provide performance monitoring while the optical link is in service, that is transmitting data. If the optical coupling elements 224, 226 selectively couple one of the transmission signal or the monitoring signal to the SLMs at a time, in-service monitoring is not possible; however, monitoring is possible when there is no transmission signal present. Additionally, the monitoring of the different spatial modes may be done in serial or in parallel. For parallel monitoring the monitoring signal passes through the SLMs 208, 210 at the same time. The monitoring signals output from the SLMs 208, 210 should be able to be separated from each other in some fashion in order to enable monitoring of the individual SLMs 208 and 210. As an example, the beam splitting element 216 may direct a selected wavelength or frequency channel to the optical coupling element 224 and so the SLM 210, and may direct a second different wavelength or frequency channel to the optical coupling element 226 and so the SLM 208. Assuming the sensor 232 is capable of distinguishing between the different wavelengths, the monitoring signals from the two SLMs 208, 210 may be separated and processed by the SLM controller in order to provide feedback on the individual SLMs 208, 210. Although described as separating or identifying the monitoring signals passing through the different SLMs using wavelength selectivity, other techniques are possible.

The multiplexer 200 includes a further optical coupling element 228. The optical coupling element 228 may be provided by a WDM combiner, switch, flip mirror, directional coupler that couples the monitoring signals passing through the SLMs to the sensor 232. When a flip mirror is used, both the monitoring signal and the SDM-OAM transmission signal are coupled to the sensor 232. One or more optical elements such as filters may be employed to filter the signal in order to isolate the monitoring signal. Other coupling elements 228 may be used, such as a WDM filter that can separate the monitoring signals from the SDM-OAM transmission signal based on differing wavelengths and couple the monitoring signal to the sensor 232 while simultaneously coupling the SDM-OAM transmission signal to the OAM-port 212 for transmission. For example, the transmission signals and the monitoring signal may have different optical frequencies and a frequency-selective switch or splitter could be employed to split the monitoring signal from the SDM-OAM transmission signal.

In order to monitor and adjust the SLMs 208, 210 independently, the monitoring signal passing through the SLMs 208, 210 need to be able to be associated with the individual SLM. This association may be done in various ways. For example, the beam splitting element 216 and/or the optical coupling elements 224, 226 may be controlled so that a monitoring signal propagates through a single SLM at a time. Accordingly, the interference pattern captured at a particular time can be associated with the SLM the monitoring signal passed through at that time. Other techniques for associating a particular monitoring beam and resulting interference pattern are possible. For example, rather than using time, the wavelength or frequency of the monitoring signals passing through the individual SLMs may differ. Regardless of how the interference patterns are associated with the particular SLMs 208, 210, the captured images provide feedback for controlling the SLMs in an attempt to reduce inter-modal crosstalk. The particular characteristics of the beam splitting element 216, optical couplers 225, 226, monitoring sensor 232, monitoring signal and transmission signals will determine whether in-service monitoring is possible, as well as whether or not it is possible to monitoring different spatial modes in parallel.

Regardless of the optical coupling element employed to couple the monitoring signals to the sensor 232, the monitoring signal passing through one of the SLMs 208, 210 reaches the sensor 232. A reference monitoring signal that has not passed through either SLM 208, 210 may be coupled to the sensor 232. The sensor may utilize the reference monitoring signals in various ways, including comparing the monitoring signals that have passed through the SLMs to the reference monitoring signal that has not passed through an SLM. Additionally or alternatively, the reference monitoring signal and the monitoring signal may be recombined, either at the sensor or at an optical coupler (not depicted) located before the sensor, and superimpose with each other. The superimposed optical signals result in an interference pattern that is captured by a camera located at the interference location. The interference pattern captured by the camera or other sensor information may be processed by an SLM controller 234. The sensor information may provide an indication of the performance characteristic of the SLMs 208, 210 and can be used to adjust operating characteristics of each of the SLMs 208, 210.

Although not depicted in FIG. 2, there may be a direct optical path from the monitoring port 214 to the OAM port 212 for the purpose of line transmission monitoring, which may function similar to the optical supervisory channels (OSCs). The monitoring components such as 214, 216, 224, SLM, 228 may also be designed to act transparently to the line monitoring signals such as OSCs. This may help in evaluating the overall link including the Mux/Demux and the transmission fiber all together for the purpose of system performance evaluations.

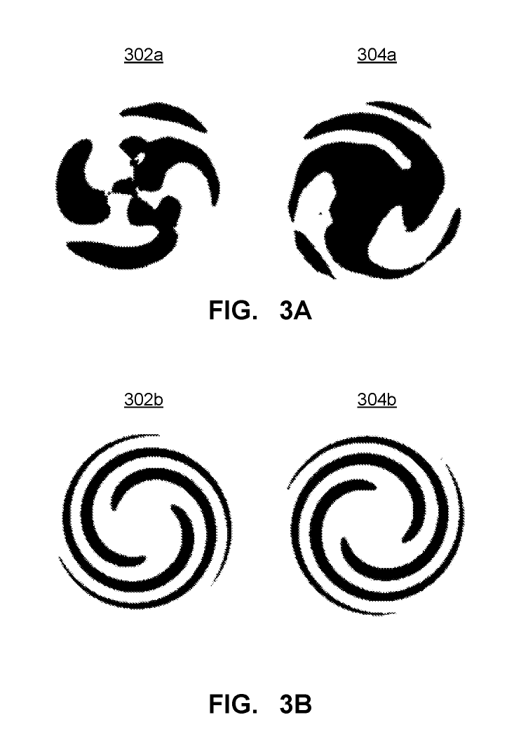

FIGS. 3A and 3B depict interference images of orbital angular momentum (OAM) spatial modes. FIG. 3A depicts interference images of OAM spatial modes captured by a camera or photodetector such as camera 232. One image 302a depicts an interference pattern for an OAM+3 spatial mode superimposed with a reference optical signal and the second image 304a depicts an interference pattern for an OAM−3 spatial modes superimposed with a reference optical signal. FIG. 3B depicts an ideal interference pattern. The interference pattern 302b is an ideal interference pattern for the OAM+3 spatial mode and the interference pattern 304b is an ideal interference pattern for the OAM−3 mode. These ideal interference patterns may be used as reference interference patterns.

FIG. 3A depicts, by way of example, the captured images of the mode profiles after a monitoring signal propagated through spatial mode converter interferes with a reference signal. An OAM optical signal has a spiraling or helical phase structure, which may also be known as an optical vortex. In such an optical vortex, light spirals in a helical manner about its axis of propagation. The optical vortex is characterized by its topological charge, indicative of the number times the light orbits per wavelength. The topological charge, or “mode number”, is always an integer, which can be either positive or negative, depending on the direction or helicity, i.e. right-handedness or left-handedness, of the spiral. In FIGS. 3A and 3B, the number of fringes indicates the mode number. The direction of the fringes (+/−) indicates the direction of the spiral. As shown in FIGS. 3A and 3B, there are three fringes, representing OAM+3 and OAM−3 (in which the plus and minus signs indicate the direction of helicity.

The images captured, for example by a camera used as the sensor 232 or other detector array, such as those presented by way of example in FIG. 3B, are compared, or correlated, with ideal interference images (such as those shown in FIG. 3B) to determine how pure or impure the modes are. The ideal interference images (e.g. the images shown in FIG. 3B) may be generated using one or more equations such as, for example, the Laguerre-Gaussian (LG) mode set and the Laguerre polynomials which are disclosed in Yao, A. M. and Padgett, M. J. (2011) Orbital angular momentum: origins, behavior and applications. Advances in Optics and Photonics, 3 (2). P. 161. ISSN 1943-8206, which are hereby incorporated by reference. This comparison or correlation between the theoretical, or ideal, interference patterns and the actual interference pattern captured in for example images of FIG. 3A thus provides an assessment of modal purity. In other words, the captured images represent the input beam wavefront. Each image correlation provides a cost function for the purity of the input beam's wavefront. The modal purity of the transmitted signal determines the level of crosstalk that will be experienced. Impure models at the OAM port 212 that is input to the SDM fiber will excite undesired modes, will sap energy from the targeted mode and will increase interference (i.e. crosstalk) by activating competing modes. Impure modes at the fiber output could be attributed to misalignment at the input if fiber propagation itself has little impact on the modes, i.e. if the fiber is well designed to support the mode of interest. Quantifying the modal purity enables the first and second SLMs 208, 210 to be controlled or adjusted in order to improve the modal purity of the transmitted optical signals. Each of the first and second SLMs 208, 210 may include adjustable (i.e. reprogrammable) pixels that operate as a phase mask or grating to control or improve the modal purity.

The degree of correlation between the captured image and an ideal interference image may be expressed in terms of a figure of merit, which is a numerical expression representing the coupling efficiency of light into the fiber. If the coupling is well aligned, i.e. the coupling efficiency is high, the modes will be pure. Conversely, if the coupling is misaligned, i.e. the coupling efficiency is low, the modes will be impure. Measuring the modal purity is thus an indication of coupling efficiency.

In one embodiment, the image comparison (or image correlation) described above is performed by the SLM controller 234. The SLM controller 234 may, for example, receive image data of a captured image from the camera 232 and perform a fringe-pattern analysis on the image data to compare the captured image with an ideal interference image stored in a memory coupled to the processor of the SLM controller. The fringe-pattern analysis may involve performing a Fourier-transform fringe-analysis method as disclosed by Takeda et al. in “Fourier-transform method fringe-pattern analysis for computer-based topography and interferometry” in J. Opt. Soc. Am, Vol. 72, No. 1, January 1982, which is hereby incorporated by reference. Instead of a fringe pattern analysis, the correlation may involve comparison of any other identifiable pattern, profile or signature. Alternatively, the processor may apply one of several digital signal processing techniques such as intensity profile mask associated with the targeted mode. Based on this correlation or other analysis, the SLM controller 234 generates a figure of merit representing a degree of correlation between detected and ideal images that is therefore indicative of modal purity. The SLM controller 234 may generate and transmit a first feedback signal to the first SLM 208 and a second feedback signal to the second SLM 210 to change (reprogram) their pixels in order to adjust the spatial modulation of the light. This active feedback to the first and second SLMs 208, 210 based on image correlation, enables the SLMs 208, 210 to improve the modal purity of the OAM modes. Improving the modal purity of the OAM modes has the effect of reducing modal crosstalk.

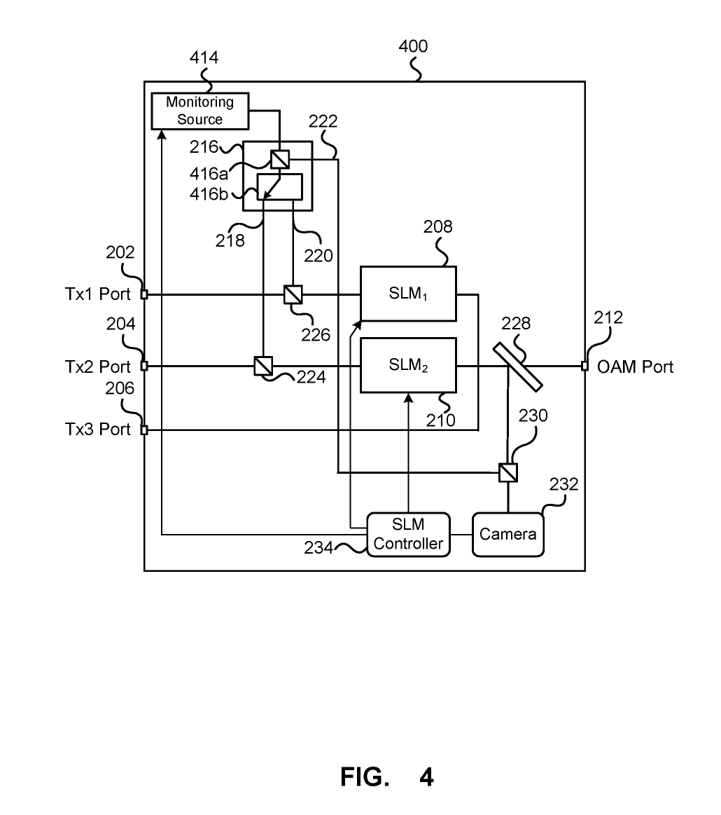

FIG. 4 depicts a further SDM multiplexer incorporating an integrated monitoring path. The SDM multiplexer 400 is similar to the SDM multiplexer 200 described above and as such similar components have been numbered accordingly and are not described further. In contrast to the SDM multiplexer 200 which incorporated a monitoring port 214 for receiving a monitoring signal, the SDM multiplexer 400 incorporates an integrated light source 414 for providing the monitoring signal. The monitoring light source 414 may be provided by, for example, light-emitting diodes (LEDs), Fabry-Perot (FP) lasers, distributed feedback (DFB) lasers, vertical cavity surface-emitting lasers (VCSELs) or another equivalent light-emitting source. The monitoring light source may provide a constant optical frequency (frequencies) or wavelength(s) or may be tunable.

The beam splitting element 216 is depicted as comprising a beam splitter 416a that splits the monitoring beam from the monitoring source 414 into two beams. One beam is coupled to the reference monitoring path 222 and the other is coupled to an optical switch 416b that selectively couples the monitoring beam to a respective one of the monitoring branches 218, 220 and optical coupling elements 224, 226.

The SLM controller 234 may control the operation of the monitoring source 414 as well as the optical switch 416b of the beam splitting element 216. It is noted that a control line from the SLM controller 234 to the optical switch 416b is not depicted for simplicity of the figure.

The monitoring source 414 provides a monitoring signal for use in monitoring the performance of the multiplexer, and in particular the SLMs 208, 210. Since the monitoring signal does not need to modulate data, there are no particular speed requirements of the light source. The main requirement for the monitoring source 414 is that the monitoring signal is orthogonal to the transmission signals. The optical signals are considered orthogonal to each other if they do not exhibit significant crosstalk. The orthogonality may be achieved in various ways, including time division, frequency division, or more advanced optical and electrical signal processing techniques such as optical CDMA (e.g., time domain, time-wavelength) coherent ultra-short pulse codings, etc. The monitoring source 414 may be controlled to ensure the desired orthogonality is provided for the transmission signals.

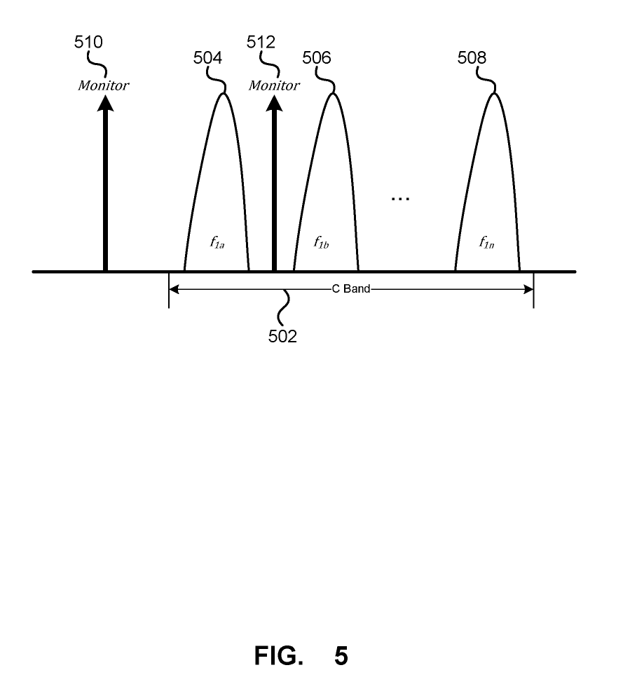

FIG. 5 depicts a frequency spectrum of a wave division multiplexing (WDM) optical signal that may be carried on a desired spatial mode along with possible monitoring signals. Although the transmission signals that are spatially modulated can be an optical signal, one possible signal is a WDM signal. The WDM signal may be spread across the C-Band frequency range 502. The WDM signal comprises a plurality of data channels at different frequencies 504, 506, 508. As described above, the monitoring source 414 is controlled in order to provide a monitoring signal that is orthogonal to the transmission signal. If time division is used, so that the two signals do not overlap in time, the monitoring signal may be at any frequency. However, if the signals overlap in time, for example to provide in-service monitoring, the monitoring signal may be provided at non-overlapping frequencies with the transmission signal. As depicted in FIG. 5, a monitoring signal 510 may be provided at a frequency, or range of frequencies, that is outside of the frequency spectrum of the transmission signals. Additionally or alternatively, a monitoring signal 512 may be provided within the frequency spectrum of the transmission signal located between channel frequencies. It will be appreciated that in addition to being orthogonal to the transmission signals, the frequency of the monitoring signal should fall inside a reliable operation window of the components of the multiplexer. Proper calibration and scaling may be required to ensure that the optimizations for the monitoring frequencies provide corresponding optimized performance for the transmission frequencies.

Although time division and frequency division techniques can provide acceptable orthogonally between the transmission signals and the monitoring signals, other techniques may be used.

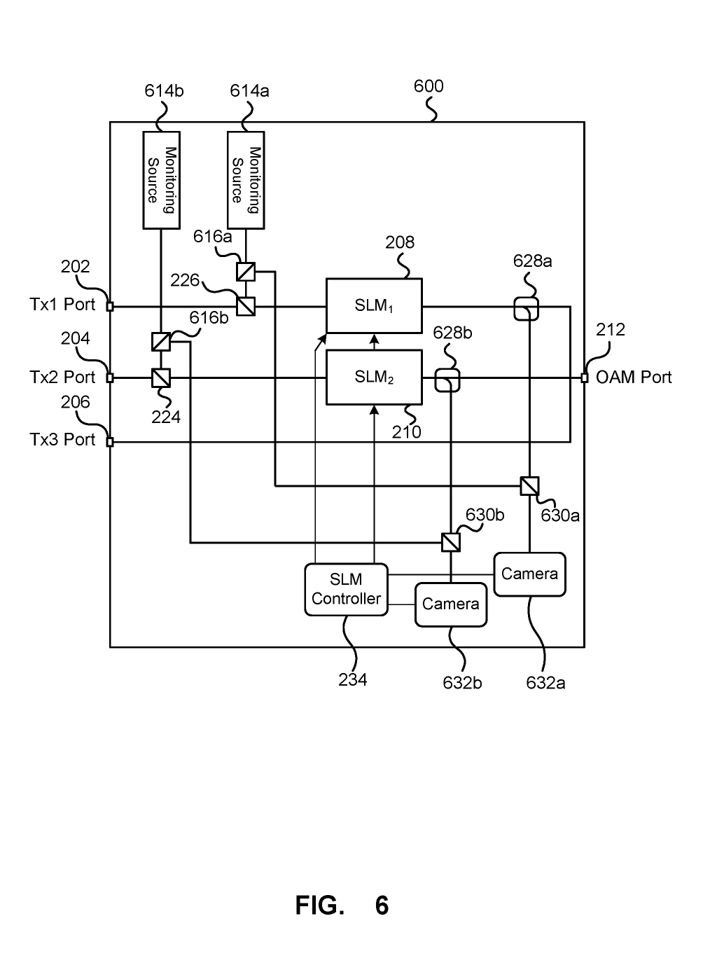

FIG. 6 depicts a further SDM multiplexer incorporating an integrated monitoring path. The SDM multiplexer 600 is similar to the SDM multiplexers 200 and 400 described above and as such similar components have been numbered accordingly and are not described further. In contrast to the SDM multiplexers 200, 400 which incorporated a common monitoring path for all of the SLMs, the SDM multiplexer 600 incorporates individual monitoring paths for each SLM. Accordingly, the multiplexer 600 comprises a first monitoring source 614a that provides a first monitoring beam to a first beam splitter 616a. One output of the beam splitter 616a is provided to an optical coupler 226 that couples the first monitoring beam to the first SLM 208. The output of the SLM 208 may pass through an optical element 628a, such as a frequency selective switch, that can selectively couple the monitoring signal to a first camera 632a and can couple the transmission signal to an OAM port 212. The first monitoring signal passing through the first SLM 208 is combined with the reference monitoring signal split from the first beam splitter at an optical coupler 630a. The combined optical signals provide an interference pattern that is captured by the camera 632a and processed by the SLM controller 234.

Similarly, a second monitoring path is provided for monitoring the performance of the second SLM 210. The second monitoring path comprises a second monitoring source 614b that provides a second monitoring beam to a second beam splitter 616b. One output of the beam splitter 616b is provided to an optical coupler 224 that couples the second monitoring beam to the second SLM 210. The output of the SLM 210 may pass through an optical element 628b, such as a frequency selective switch, that can selectively couple the second monitoring signal to a second camera 632b and can couple the transmission signal to an OAM port 212. The second monitoring signal passing through the second SLM 210 is combined with the reference monitoring signal split from the second beam splitter at an optical coupler 630b. The combined optical signals provide an interference pattern that is captured by the second camera 632b and processed by the SLM controller 234.

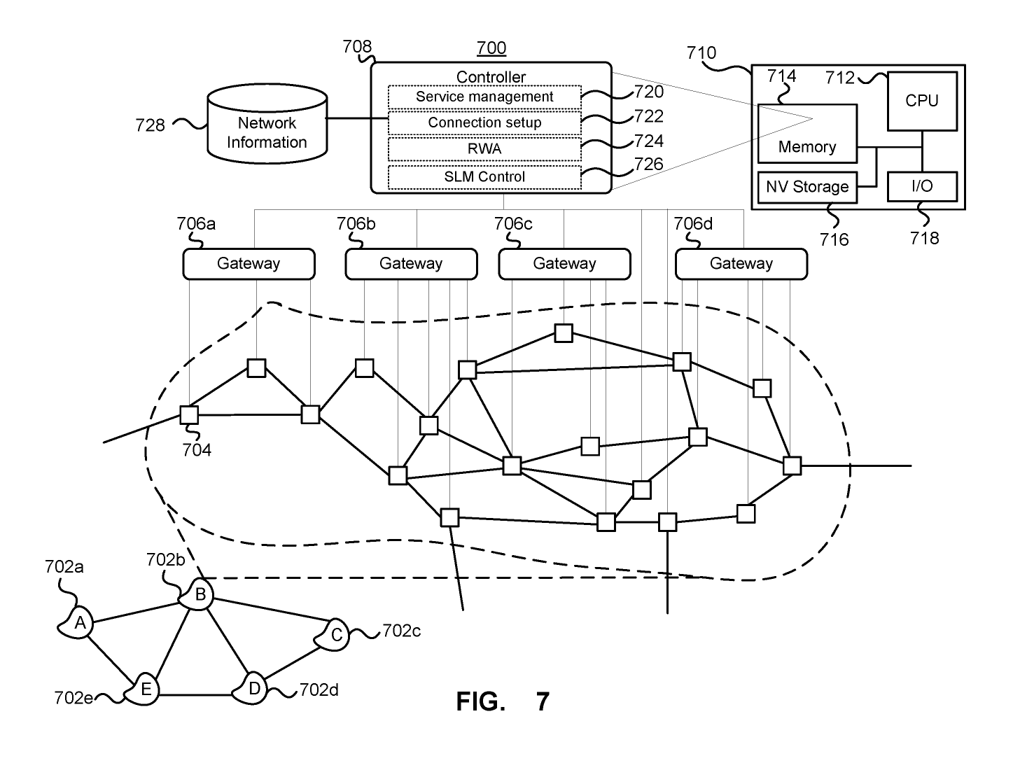

FIG. 7 depicts a schematic of an optical network and control system. The optical network and control system 700 may provide a software defined networking (SDN) optical network incorporating crosstalk-based transmission adjustment of SDM optical signals. The optical network and control system 700 comprises an optical network and a controller 708 for configuring components of the optical network. The optical network may comprise a number of interconnected optical networks 702a, 702b, 702c, 702d, 702e (referred to as optical networks 702). The group of optical networks 702 may provide a multi-domain network with each of the individual optical networks 702 providing a separate domain. Each of the optical networks 702 may comprise a number of interconnected optical components, depicted as individual squares 704. The interconnected optical components 704 may include for example network access nodes, or optical switches. The optical switches may provide utilizing reconfigurable add-drop multiplexer ROADM based architectures that are connected to other access nodes or switches via fiber optic cables or links. A network segment may correspond to a piece of the network between two connected access nodes. One or more of the optical networks 702 may include one or more optical links comprising an SDM optical link that multiplexes a plurality of optical signals onto different spatial modes of the SDM optical link. The SDM multiplexed links may incorporate SDM multiplexers that provide integrated monitoring paths that provide monitoring of the SDM multiplexer characteristics independent of the data signals being transmitted. The integrated monitoring allows monitoring and tuning of “dark” optical links prior to transmitting data as well as monitoring and tuning of optical links while in service without placing any requirements or restrictions on the data signals.

A data plane may be established between the optical components 704 to carry the network traffic. Additionally, a control plane can also established within the optical network to provide a communication network between the network access nodes 704 and the controller 708. The control plane may be established over the data plane, for example using a time slot, or particular wavelength, of the data plane to transmit the control plane, or through a packet based network used to interconnect control and management of nodes 704. The control plane may connect one or more of the access nodes 704 directly to the controller 708, or through one or more gateways 706a, 706b, 706c, 706d. The control plane allows the controller 708 to request, or otherwise receive, control information, such as performance related information including measured performance metrics, usage information, etc., from the network access nodes 704, and to send configuration commands, including for example commands for adjusting one or more transmission characteristics and corresponding reception characteristics, to the network access nodes 704 or other components of the optical network. The parameters monitored by nodes may be accessed in various ways, including, for example by periodically pulling or requesting the parameters from the nodes, pulling or requesting the parameters on demand when they are required, periodically pushing the parameters from the node for storage and subsequent access from the storage location, or pushing the parameters from the node for storage and subsequent access when the parameter changes.

The controller 708 may be provided by a server 710 comprising a processor 712 for executing instructions stored in memory 714. In addition to the memory 714, the server 710 may also include non-volatile storage 716 for long term storage of instructions and data. The server 710 may also include one or more input/output (I/O) components 718 for connecting the server to one or more other components. Although depicted as a single server 710, the functionality provided by the controller 708 may be distributed over a plurality of devices. Further multiple controllers may be provided by one or more servers.

The controller 708 may provide various functionality for configuring and controlling the optical network. For example, the controller 708 may provide service management functionality 720, connection setup functionality 722 as well as route and wavelength assignment (RWA) functionality 724. The controller 708 may include SLM control functionality 726 that can monitor performance metrics of an SDM optical multiplexer and adjust characteristics of one or more of the multiplexer's SLMs in order to reduce intermodal crosstalk. The SLM control functionality 726 may periodically request and receive the monitored performance metrics from the access nodes 704, which may include for example monitoring sensor data such as captured interference pattern data or results from local processing of the captured interference pattern, either directly or through one or more gateways 706. The received metrics may be stored for example in a network information database 728. Additionally or alternatively, the SLM control functionality 726 may request and receive the monitored metrics from the access nodes 704 when the metrics are required, for example when determining possible adjustments to make to reduce intermodal crosstalk. Further still, the access nodes 704 may periodically push measured metrics to the SLM control functionality 726 or may push parameters to the SLM control functionality 726 when the parameters change. The SLM control functionality 726 may utilize the monitored metrics in order to adjust the SDM multiplexed signals to reduce crosstalk as described above. The information captured via the SLM control agent may be used for service management (720), connection setup (722), and RWA (724).

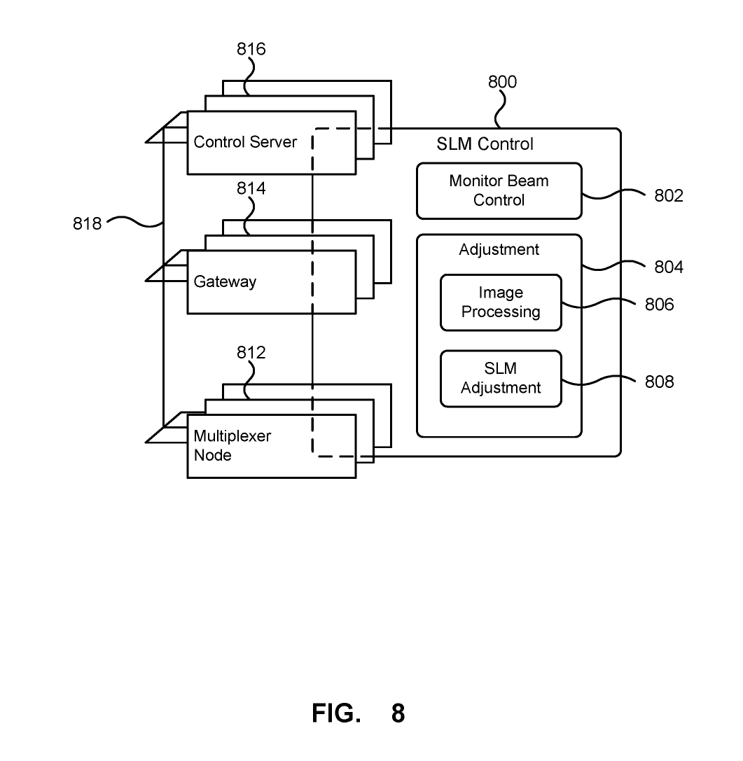

FIG. 8 is a schematic representation of a distributed SLM controller. As described above with reference to FIG. 7, the optical network and controller may be provided by a plurality of different components, including a plurality of interconnected nodes 704 or switches, one or more gateway nodes 706 that may be in communication with a plurality of the nodes 704 and one or more controllers that control the overall operation of the optical network. As depicted in FIG. 8, the controller functionality and in particular the SLM control functionality described above, as well as that described below, may be distributed among the different hardware components. The SLM control functionality 800 may be implemented across different components of the optical network. As depicted, portions of the SLM control functionality 800 may be distributed among network nodes including SDM multiplexer nodes 812, gateways 814 and control servers 816. As depicted the various components are communicatively coupled together by a control plane 818. The nodes 812, gateways 814 and control servers 816 can each implement different portions of the SLM control functionality 800. As will be appreciated, the particular portions of the SLM control functionality that is implemented in a particular component may vary.

The SLM control functionality 800 that is distributed amongst numerous components may include monitor beam control functionality 802 for controlling a monitoring beam. The monitor beam control functionality may control characteristics of the monitoring source, such as the optical frequency of the beam as well as other components of the multiplexer so that the monitoring beam passes through a desired SLM and a resulting interference pattern is captured by a camera. Adjustment functionality 804 may include image processing functionality 806 that compares a captured interference pattern to an ideal or desired interference pattern. Based on the results of the comparison SLM adjustment functionality 808 may adjust operating characteristics of the SLMs in order to reduce the inter-modal crosstalk.

The present disclosure provided, for the purposes of explanation, numerous specific embodiments, implementations, examples and details in order to provide a thorough understanding of the invention. It is apparent, however, that the embodiments may be practiced without all of the specific details or with an equivalent arrangement. In other instances, some well-known structures and devices are shown in block diagram form, or omitted, in order to avoid unnecessarily obscuring the embodiments of the invention. The description should in no way be limited to the illustrative implementations, drawings, and techniques illustrated, including the exemplary designs and implementations illustrated and described herein, but may be modified within the scope of the appended claims along with their full scope of equivalents.

While several embodiments have been provided in the present disclosure, it should be understood that the disclosed systems and components might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A spatial mode multiplexer comprising:
a spatial mode converter for converting a spatial mode of an optical signal;
a transmit optical path for propagating the optical signal, wherein the transmit optical path is coupled to the spatial mode converter;
a monitoring optical path comprising a branch coupled to the spatial mode converter; and
an optical coupling element for optically coupling at least a portion of the optical signal having the spatial mode converted by the spatial mode converter to at least one of:
an output transmit path for propagating the converted spatial mode; and
a monitoring sensor path for coupling to an optical sensor for detecting an optical signal propagated along the monitoring optical path.

2. The spatial mode multiplexer of claim 1, further comprising a reference optical path bypassing the spatial mode converter and configured for combining an optical signal propagated along the reference optical path with the optical signal propagated along the monitoring optical path to obtain an optical interference pattern at the optical sensor.

3. The spatial mode multiplexer of claim 2, further comprising the optical sensor.

4. The spatial mode multiplexer of claim 3, further comprising a controller operably coupled to the optical sensor and configured for:
obtaining the optical interference pattern from the optical sensor;
comparing the optical interference pattern with a reference pattern; and
providing a feedback signal to the spatial mode converter for changing the spatial mode of the optical signal so as to lessen a difference between the optical interference pattern and the reference pattern.

5. The spatial mode multiplexer of claim 2, further comprising a light source optically coupled to the monitoring and reference optical paths, for providing the optical signal for propagation along the monitoring and reference optical paths.

6. The spatial mode multiplexer of claim 2, further comprising:
a second spatial mode converter for converting a spatial mode of a second optical signal;
a second transmit optical path for propagating the second optical signal, wherein the second transmit optical path is coupled to the second spatial mode converter;
wherein the monitoring optical path further comprises a second branch coupled to the second spatial mode converter, and wherein the optical coupling element is further for coupling at least a portion of the optical signal having the spatial mode converted by the second spatial mode converter to at least one of:
the output transmit path; and
the monitoring optical path.

7. The spatial mode multiplexer of claim 6, wherein the spatial mode multiplexer comprises an orbital angular momentum (OAM) multiplexer, wherein the spatial mode converter comprises a spatial light modulator (SLM) for providing a pre-determined spatial phase pattern to the optical signal, and wherein the second spatial mode converter comprises a second spatial light modulator (SLM) for providing a pre-determined spatial phase pattern to the second optical signal.

8. The spatial mode multiplexer of claim 7, wherein outputs of the SLM and second SLM are optically combined to provide a spatially multiplexed optical signal to the optical coupling element.

9. The spatial mode multiplexer of claim 8, further comprising a third transmit optical path for optically combining a third optical signal with the outputs of the SLM and the second SLM, the third optical signal having spatial mode that can be spatially multiplexed with the outputs of the SLM and second SLM.

10. The spatial mode multiplexer of claim 8, further comprising the optical sensor and a controller operably coupled thereto and configured for:
obtaining the optical interference pattern from the optical sensor;
comparing the optical interference pattern with a reference pattern; and
providing a feedback signal to the SLM and the second SLM for changing the spatial mode of the optical signal so as to lessen a difference between the optical interference pattern and the reference pattern.

11. The spatial mode multiplexer of claim 8, further comprising a light source optically coupled to the monitoring and reference optical paths, for providing the optical signal for propagation along the monitoring and reference optical paths.

12. The spatial mode multiplexer of claim 1, wherein the optical coupling element comprises:
a WDM coupler;
a beam splitter/combiner;
a flip mirror; or
an optical switch.

13. The spatial mode multiplexer of claim 12, further comprising
a monitoring path optical coupling element for optically coupling the branch of the monitoring optical path to the transmit optical path upstream of the spatial mode converter.

14. The spatial mode multiplexer of claim 13, wherein the monitoring path optical coupling element comprises one or more of:
a WDM coupler;
a beam splitter/combiner;
a flip mirror; and
an optical switch.

15. The spatial mode multiplexer of claim 6, wherein the monitoring optical path comprises:
a beam splitter for splitting a monitoring optical signal between the monitoring and reference optical paths; and
a monitoring branch optical coupling element in the monitoring optical path downstream of the beam splitter for coupling a portion of the monitoring optical signal to the branch of the monitoring optical path and the second branch of the monitoring optical path.

16. The spatial mode multiplexer of claim 15, wherein the monitoring branch optical coupling element selectively couples the portion of the monitoring optical signal to one of the branch of the monitoring optical path and the second branch of the monitoring optical path.

17. A method for configuring a spatially multiplexed optical link, the method comprising:
receiving a probe optical signal;
spatially modulating at least a portion of the probe optical signal at a spatial mode converter used for converting a spatial mode of a transmit optical signal for transmission to a destination;
coupling the spatially modulated probe optical signal to an optical sensor; and
generating a feedback signal for adjusting the spatial mode converter based on an output of the optical sensor.

18. The method of claim 17, wherein the transmit optical signal is not present at the spatial mode converter prior to generating the feedback signal.

19. The method of claim 17, wherein the transmit optical signal is present at the spatial mode converter during generation of the feedback signal.

20. The method of claim 19, wherein an optical frequency of the monitoring signal falls outside of an optical frequency spectrum of the transmit optical signal, or falls between channel frequencies of the transmit optical signal.

21. The method of claim 17, further comprising:
splitting the received probe optical signal into a monitoring optical signal for propagation through the spatial mode converter and a reference optical signal bypassing the spatial mode converter, and combining the monitoring optical signal propagated through the spatial mode converter with the reference optical signal, so as to form an optical interference pattern for detection by the optical sensor.

22. The method of claim 21, wherein the optical sensor comprises a detector array, and the method further comprises:
capturing the optical interference pattern by the detector array.

23. The method of claim 22, further comprising comparing the captured optical interference pattern with a reference pattern, wherein the feedback signal is generated based on a difference between the optical interference pattern and the reference pattern.
